(19) United States
(12) Patent Application Publication
(10) Pub. No.: US 2026/0332490 A1
(43) Pub. Date: Oct. 22, 2026

(54) ASSISTANCE INFORMATION PROVISION FOR LCM

(71) Applicant: LENOVO (BEIJING) LIMITED, Beijing (CN)

(72) Inventors: Congchi Zhang, Shanghai (CN); Jianfeng Wang, Beijing (CN); Bingchao Liu, Beijing (CN)

(73) Assignee: LENOVO (BEIJING) LIMITED, Beijing (CN)

(21) Appl. No.: 19/484,103

(22) PCT Filed: Jul. 13, 2023
(86) PCT No.: PCT/CN2023/107249

§ 371 Date: Nov. 13, 2025

(51) Int. Cl. H04L 41/16; H04W 24/02; H04W 36/00

(52) U.S. Cl. CPC H04L 41/16; H04W 24/02; H04W 36/0083

(57) ABSTRACT

Embodiments of the present disclosure relate to network units, methods, apparatuses, and computer readable medium for assistance information provision for LCM. In some embodiments, the first network unit may transmit, to a second network unit, assistance information for an LCM associated with an AI/ML based operation. Accordingly, the second network unit may perform the LCM based on the assistance information. In some embodiments, the first network unit may further receive a message which is related to the assistance information from the second network unit, e.g., the message may include an indication of AI/ML information in use at the second network unit or at a UE. Therefore, the assistance information may be provided from the first network unit to the second network unit, and thus an LCM procedure at the second network unit may be assisted.

### TECHNICAL FIELD

The present disclosure relates to wireless communications, and more specifically to network units, methods, apparatuses, and computer readable medium for assistance information provision for life cycle management (LCM).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A mechanism to enable artificial intelligence (AI) or machine learning (ML) based physical layer operation is discussed by the third generation partnership project (3GPP). A related AI model may be deployed at UE side or network side. In case of central unit (CU)—distributed unit (DU) split gNB architecture, the AI model may be deployed at the UE or at the DU, and an LCM for the AI model usage may be performed at the DU. However, how to facilitate the LCM at the DU is still needed to be studied.

### SUMMARY

The present disclosure relates to network units, methods, apparatuses, and computer readable medium for assistance information provision for LCM.

In a first aspect, there is provided a first network unit. The first network unit comprises at least one memory; and at least one processor coupled with the at least one memory and configured to cause the first network unit to: transmit, to a second network unit, assistance information for an LCM associated with an AI/ML based operation; and receive, from the second network unit, a message being related to the assistance information.

In a second aspect, there is provided a second network unit. The second network unit comprises at least one memory; and at least one processor coupled with the at least one memory and configured to cause the second network unit to: receive, from a first network unit, assistance information for an LCM associated with an AI/ML based operation; and transmit, to the first network unit, a message being related to the assistance information.

In a third aspect, there is provided a third network unit. The third network unit comprises at least one memory; and at least one processor coupled with the at least one memory and configured to cause the third network unit to: receive, from a first network unit or a fourth network unit, a UE context setup request comprising AI/ML information in use at a second network unit or at a UE; and transmit, to the first network unit or the fourth network unit, a UE context setup response comprising an activated AI/ML information.

In a fourth aspect, there is provided a fourth network unit. The fourth network unit comprises at least one memory; and at least one processor coupled with the at least one memory and configured to cause the fourth network unit to: receive, from a first network unit, a handover request comprising AI/ML information in use at a second network unit or at a UE; transmit, to a third network unit, a UE context setup request comprising the AI/ML information in use at the second network unit or at the UE; receive, from the third network unit, a UE context setup response comprising an activated AI/ML information being activated by the third network unit; and transmit, to the first network unit, a handover response comprising the activated AI/ML information.

In a fifth aspect, there is provided a method performed by the first network unit. The method comprises: transmitting, to a second network unit, assistance information for an LCM associated with an AI/ML based operation; and receiving, from the second network unit, a message being related to the assistance information.

In a sixth aspect, there is provided a method performed by the second network unit. The method comprises: receiving, from a first network unit, assistance information for an LCM associated with an AI/ML based operation; and transmitting, to the first network unit, a message being related to the assistance information.

In a seventh aspect, there is provided a method performed by the third network unit. The method comprises: receiving, from a first network unit or a fourth network unit, a UE context setup request comprising AI/ML information in use at a second network unit or at a UE; and transmitting, to the first network unit or the fourth network unit, a UE context setup response comprising an activated AI/ML information.

In an eighth aspect, there is provided a method performed by the fourth network unit. The method comprises: receiving, from a first network unit, a handover request comprising AI/ML information in use at a second network unit or at a UE; transmitting, to a third network unit, a UE context setup request comprising the AI/ML information in use at the second network unit or at the UE; receiving, from the third network unit, a UE context setup response comprising an activated AI/ML information being activated by the third network unit; and transmitting, to the first network unit, a handover response comprising the activated AI/ML information.

In a ninth aspect, there is provided a processor for wireless communication. The processor comprises at least one controller coupled with at least one memory and configured to cause the processor to: transmit, to a second network unit, assistance information for an LCM associated with an AI/ML based operation; and receive, from the second network unit, a message being related to the assistance information.

In a tenth aspect, there is provided a processor for wireless communication. The processor comprises at least one controller coupled with at least one memory and configured to cause the processor to: receive, from a first network unit, assistance information for an LCM associated with an AI/ML based operation; and transmit, to the first network unit, a message being related to the assistance information.

In an eleventh aspect, there is provided a processor for wireless communication. The processor comprises at least one controller coupled with at least one memory and configured to cause the processor to: receive, from a first network unit or a fourth network unit, a UE context setup request comprising AI/ML information in use at a second network unit or at a UE; and transmit, to the first network unit or the fourth network unit, a UE context setup response comprising an activated AI/ML information.

In a twelfth aspect, there is provided a processor for wireless communication. The processor comprises at least one controller coupled with at least one memory and configured to cause the processor to: receive, from a first network unit, a handover request comprising AI/ML information in use at a second network unit or at a UE; transmit, to a third network unit, a UE context setup request comprising the AI/ML information in use at the second network unit or at the UE; receive, from the third network unit, a UE context setup response comprising an activated AI/ML information being activated by the third network unit; and transmit, to the first network unit, a handover response comprising the activated AI/ML information.

In some implementations of the method and the first network unit described herein, a suggestion regarding whether using AI or ML information to serve a UE, suggested UE side AI or ML information to be activated or deactivated, or suggested network side AT or ML information to be activated or deactivated.

In some implementations of the method and the first network unit described herein, the assistance information indicates at least one of: an expected arrival time of a UE from the second network unit to a third network unit, an expected moving state of the UE, wherein the expected moving state is stationary or mobile, an expected activity time of the UE in a radio resource control (RRC) connected state, an expected idle time of the UE in an RRC inactive state or an RRC idle state, whether the UE is a cell edge UE, a moving velocity of the UE, or a moving direction of the UE.

In some implementations of the method and the first network unit described herein, the message comprises an indication of AI or ML information in use at the second network unit or at a UE, wherein the AI or ML information in use is determined based on the assistance information.

In some implementations of the method and the first network unit described herein, the first network unit receives, from the second network unit, a first indication of AI or ML information to be used at the second network unit.

In some implementations of the method and the first network unit described herein, the first network unit receives, from a UE, a second indication of AI or ML information to be used at the UE.

In some implementations of the method and the first network unit described herein, the first network unit is a CU and the second network unit is a DU.

In some implementations of the method and the first network unit described herein, the first network unit transmits, to a third network unit, a UE context setup request comprising the AT or ML information in use at the second network unit or at a UE; and receives, from the third network unit, a UE context setup response comprising an activated AI or ML information.

In some implementations of the method and the first network unit described herein, the second network unit is a source DU, the third network unit is a target DU, and the first network unit is a CU.

In some implementations of the method and the first network unit described herein, the first network unit transmits, to a fourth network unit, a handover request comprising the AI or ML information in use at the second network unit or at a UE; and receives, from the fourth network unit, a handover response comprising an activated AI or ML information being activated by a third network unit.

In some implementations of the method and the first network unit described herein, the fourth network unit is a target CU and the third network unit is a target DU.

In some implementations of the method and the first network unit described herein, an identifier (ID), an index, or meta information is used for identifying the AI or ML information.

In some implementations of the method and the first network unit described herein, the AI or ML information comprises one of: one or more AI or ML features, one or more AI or ML functionalities, or one or more AI or ML models.

In some implementations of the method and the first network unit described herein, the AI or ML based operation comprises one of: an AI or ML based channel state information (CSI) enhancement, an AI or ML based beam management, or an AI or ML based positioning accuracy enhancement.

In some implementations of the method and the second network unit described herein, the assistance information indicates at least one of: a suggestion regarding whether using AI or ML information to serve a UE, suggested UE side AI or ML information to be activated or deactivated, or suggested network side AI or ML information to be activated or deactivated.

In some implementations of the method and the second network unit described herein, the assistance information indicates at least one of: an expected arrival time of a UE from the second network unit to a third network unit, an expected moving state of the UE, wherein the expected moving state is stationary or mobile, an expected activity time of the UE in an RRC connected state, an expected idle time of the UE in an RRC inactive state or an RRC idle state, whether the UE is a cell edge UE, a moving velocity of the UE, or a moving direction of the UE.

In some implementations of the method and the second network unit described herein, the second network unit performs the LCM based on the assistance information to determine AI or ML information in use at the second network unit or at a UE; and wherein the message comprises an indication of AI or ML information in use at the second network unit or at the UE.

In some implementations of the method and the second network unit described herein, the second network unit transmits, to the first network unit, a first indication of AI or ML information to be used at the second network unit.

In some implementations of the method and the second network unit described herein, the first network unit is a CU and the second network unit is a DU.

In some implementations of the method and the second network unit described herein, an ID, an index, or meta information is used for identifying the AI or ML information.

In some implementations of the method and the second network unit described herein, the AI or ML information comprises one of: one or more AI or ML features, one or more AI or ML functionalities, or one or more AI or ML models.

In some implementations of the method and the second network unit described herein, the AI or ML based operation comprises one of: an AI or ML based CSI enhancement, an AI or ML based beam management, or an AI or ML based positioning accuracy enhancement.

In some implementations of the methods, the third network unit, and the fourth network unit described herein, the first network unit is a source CU, the second network unit is a source DU, the third network unit is a target DU, and the fourth network unit is a target CU.

In some implementations of the methods, the third network unit, and the fourth network unit described herein, an ID, an index, or meta information is used for identifying the AI or ML information.

In some implementations of the methods, the third network unit, and the fourth network unit described herein, the AI or ML information comprises one of: one or more AI or ML features, one or more AI or ML functionalities, or one or more AI or ML models.

### BRIEF DESCRIPTION OF THE DRAWINGS

FIG. 1 illustrates an example of a wireless communications system in which some embodiments of the present disclosure can be implemented;

FIG. 2 illustrates a schematic diagram of AI/ML information in accordance with some example embodiments of the present disclosure;

FIG. 3 illustrates a schematic diagram of an example communication network in which some embodiments of the present disclosure can be implemented;

FIG. 4 illustrates an example of a process flow in accordance with some example embodiments of the present disclosure;

FIG. 5 illustrates another example of a process flow of assistance information provision in accordance with some example embodiments of the present disclosure;

FIG. 6 illustrates an example of a process flow of an intra-gNB-CU handover in accordance with some example embodiments of the present disclosure;

FIG. 7 illustrates an example of a process flow of an inter-gNB-CU handover in accordance with some example embodiments of the present disclosure;

FIG. 8 illustrates an example of a device that is suitable for implementing embodiments of the present disclosure;

FIG. 9 illustrates an example of a processor that is suitable for implementing some embodiments of the present disclosure;

FIG. 10 illustrates a flowchart of a method that performed by a first network unit in accordance with aspects of the present disclosure;

FIG. 11 illustrates a flowchart of a method that performed by a second network unit in accordance with aspects of the present disclosure;

FIG. 12 illustrates a flowchart of a method that performed by a third network unit in accordance with aspects of the present disclosure; and

FIG. 13 illustrates a flowchart of a method that performed by a fourth network unit in accordance with aspects of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

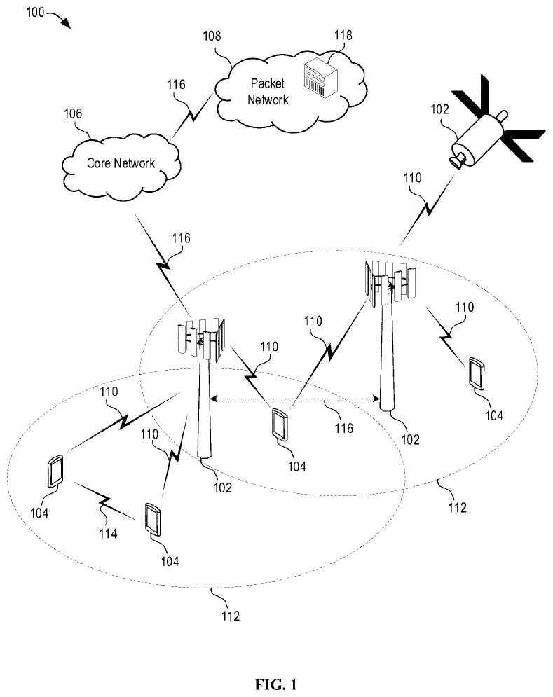

FIG. 1 illustrates an example of a wireless communications system 100 in which some embodiments of the present disclosure can be implemented. The wireless communications system 100 may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as a long term evolution (LTE) network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink (SL). For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N3, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (TAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-C, F1-U), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N3, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., =0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the present disclosure, the term “network unit” may also be interchangeably used with network entity, network node, RAN unit, RAN node, RAN entity, RAN device, or the like, the present disclosure does not limit this aspect.

In the present disclosure, AI or ML information may be represented as AI/ML information, which may include one or more AI/ML features, one or more AI/ML functionalities, or one or more AI/ML models. In some examples, the AI/ML information may be used interchangeably with AI/ML feature/functionality/model, or AI/ML based feature/functionality/model, or the like, the present disclosure does not limit this aspect.

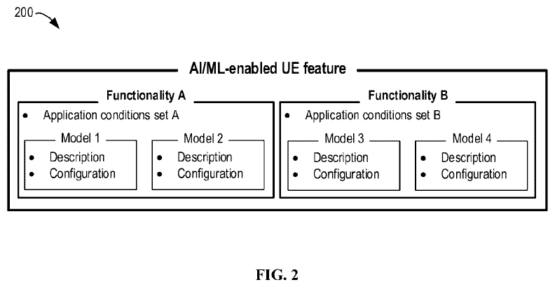

In some examples, the AI/ML features may be called as AI/ML-enabled feature groups. FIG. 2 illustrates a schematic diagram 200 of AI/ML information in accordance with some example embodiments of the present disclosure. In FIG. 2, an association of AI/ML-enabled UE feature, AI/ML functionality, and AI/ML model is shown.

AI/ML-enabled feature group (FG) basically means if the UE is capable of AI/ML-enabled CSI compression, CSI prediction, Beam prediction, Positioning etc. It gives the highest-level description of UE supported AI/ML based physical operation.

AI/ML functionality gives intermediate level description that UE supports AI/ML based physical operation under certain configurations/conditions as exampled by the Table 1 below. For example, the UE is capable of CSI feedback compression in ease of UMa scenario and being configured with certain CSI-RS.

AI/ML model is the finest granularity that UE performs AI/ML inference.

TABLE 1

| | | Potential |
|---|---|---|
| | | application |
| | Potential configurations | conditions |
| CSI feedback | CSI-RS configurations, e.g., | UMa, UMi, . . . |
| compression | # ports. | Spatial angle spread |
| | Number of layers/ranks | SNR range |
| | Quantization method | |
| CSI prediction | CSI-RS configurations, e.g., | UMa, UMi, . . . |
| | # ports, periodicity | UE velocity range |
| | Observation/prediction | SNR range |
| | window | |
| BM-Case1 | CSI-RS configurations, e.g., | UMa, UMi, . . . |
| | # ports | SNR range |
| | Size of Beam Set A/B/C | |
| | Value of K | |
| BM-Case2 | CSI-RS configurations, e.g., | UMa, UMi, . . . |
| | # ports, periodicity | UE velocity range |
| | Observation/prediction | |
| | window | |
| Direct AI/ML | PRS/SRS configurations | UMa, UMi, . . . |
| positioning | Number of TRPs | SNR range |
| | | Applicable Area, e.g., |
| | | zone, environment |
| AI/ML-assisted | PRS/SRS configurations | UMa, UMi, . . . |
| positioning | Number of TRPs | SNR range |
| | | Applicable Area e.g., |
| | | zone, environment |

The present disclosure relates to an LCM performed by a DU. The LCM (or LCM procedure) may be associated with AI or ML based operation. For example, the LCM may be functionality-based LCM or model-based LCM.

In some examples, an LCM of AI/ML model may be characterized, e.g., model training, model deployment, model inference, model monitoring, model updating.

The following aspects, including the definition of components (if needed) and necessity, are studied in Life Cycle Management:
Data collection
   Note: This also includes associated assistance information, if applicable.
Model training
Functionality/model identification
Model transfer
Model inference operation
Functionality/model selection, activation, deactivation, switching, and fallback operation.
   Including: Decision by the network (either network initiated or UE-initiated and requested to the network), decision by the UE (event-triggered as configured by the network, UE's decision reported to the network, or UE-autonomous either with UE's decision reported to the network or without it)
Functionality/model monitoring
Model update
   Note: Terminology is to be defined. This includes model finetuning, retraining, and re-development via online/offline training.
UE capability

It is noted that some aspects in the list may not have specification impact. Aspects with square brackets are tentative and pending terminology definition. More aspects may be added as study progresses.

The LCM procedure is studied on the basis that an AI/ML model has a model ID with associated information and/or model functionality at least for some AI/ML operations.

For UE-side models and UE-part of two-sided models:
For AI/ML functionality identification
   Reuse legacy 3GPP framework of Features as a starting point for discussion.
   UE indicates supported functionalities/functionality for a given sub-use-case.
      UE capability reporting is taken as starting point.
For AI/ML model identification
   Models are identified by model ID at the Network. UE indicates supported AI/ML models.

In functionality-based LCM, network indicates activation/deactivation/fallback/switching of AI/ML functionality via 3GPP signalling (e.g., RRC, MAC-CE, DCI). Models may not be identified at the Network, and UE may perform model-level LCM. Whether and how much awareness/interaction NW should have about model-level LCM will be studied. For functionality identification, there may be either one or more than one Functionalities defined within an AI/ML-enabled feature, whereby AI/ML-enabled Feature refers to a Feature where AI/ML may be used.

For AI/ML functionality identification and functionality-based LCM of UE-side models and/or UE-part of two-sided models, functionality refers to an AI/ML-enabled Feature/FG enabled by configuration(s), where configuration(s) is(are) supported based on conditions indicated by UE capability. Correspondingly, functionality-based LCM operates based on, at least, one configuration of AI/ML-enabled Feature/FG or specific configurations of an AI/ML-enabled Feature/FG.

After functionality identification, necessity, mechanisms, for UE to report updates on applicable functionality(ies) among [configured/identified] functionality(ies), where the applicable functionalities may be a subset of all [configured/identified] functionalities are studied.

In model-ID-based LCM, models are identified at the Network, and Network/UE may activate/deactivate/select/switch individual AI/ML models via model ID.

For AI/ML model identification and model-ID-based LCM of UE-side models and/or UE-part of two-sided models, model-ID-based LCM operates based on identified models, where a model may be associated with specific configurations/conditions associated with UE capability of an AI/ML-enabled Feature/FG and additional conditions (e.g., scenarios, sites, and datasets) as determined/identified between UE-side and NW-side.

From RANI perspective, an AI/ML model identified by a model ID may be logical, and how it maps to physical AI/ML model(s) may be up to implementation. When distinction is necessary for discussion purposes, companies may use the term a logical AI/ML model to refer to a model that is identified and assigned a model ID, and physical AI/ML model(s) to refer to an actual implementation of such a model.

After model identification, necessity, mechanisms, for UE to report updates on applicable UE part/UE-side model(s), where the applicable models may be a subset of all identified models are studied.

For example, data collection may be performed for different purposes in LCM, e.g., model training, model inference, model monitoring, model selection, model update, etc. each may be done with different requirements and potential specification impact.

In the present disclosure, AI/ML based physical layer operation is related, e.g., AI based CSI feedback enhancement, AI based beam management, and AI based positioning.

### AI Based CSI Feedback Enhancement

The following are selected as representative sub-use cases:
Spatial-frequency domain CSI compression using two-sided AI model. Note: All pre-processing/post-processing, quantization/de-quantization are within the scope of the sub use case.
   The study of AI/ML based CSI compression should be based on the legacy CSI feedback signalling framework.
Time domain CSI prediction using UE sided model

Considered AI/ML model training collaborations include:
Type 1: Joint training of the two-sided model at a single side/entity, e.g., UE-sided or Network-sided.
Type 2: Joint training of the two-sided model at network side and UE side, respectively.
Type 3: Separate training at network side and UE side, where the UE-side CSI generation part and the network-side CSI reconstruction part are trained by UE side and network side, respectively.
Note: Joint training means the generation model and reconstruction model should be trained in the same loop for forward propagation and backward propagation. Joint training could be done both at single node or across multiple nodes (e.g., through gradient exchange between nodes).
Note: Separate training includes sequential training starting with UE side training, or sequential training starting with NW side training [, or parallel training] at UE and NW
Note: training collaboration Type 2 over the air interface for model training (not including model update) is concluded to be deprioritized in Rel-18 study item.

Pros/cons of different offline training collaboration types are analyzed with respect to the following aspects:
Whether model can be kept proprietary,
Requirements on privacy-sensitive dataset sharing,
Flexibility to support cell/site/scenario/configuration specific model,
gNB/device specific optimization—i.e., whether hardware-specific optimization of the model is possible, e.g. compilation for the specific hardware,
Model update flexibility after deployment,
feasibility of allowing UE side and NW side to develop/update models separately,
Model performance based on evaluation,
Whether gNB can maintain/store a single/unified model,
Whether UE device can maintain/store a single/unified model,
Extendability: to train new UE-side model compatible with NW-side model in use; Or to train new NW-side model compatible with UE-side model in use,
Whether training data distribution can be matched to the device that will use the model for inference,
Whether device capability can be considered for model development,
Other aspects are not precluded,
Note: training data collection and dataset/model delivery will be discussed separately].

### AI Based Beam Management

The following are selected as representative sub-use cases:
BM-Case1: Spatial-domain Downlink beam prediction for Set A of beams based on measurement results of Set B of beams
   Consider: Alt. 1): AI/ML model training and inference at NW side. Alt. 2): AI/ML model training and inference at UE side.
   Consider: Alt. i): Set A and Set B are different (Set B is NOT a subset of Set A). Alt. ii): Set B is a subset of Set A. Note: Set A is for DL beam prediction and Set B is for DL beam measurement. The beam patterns of Set A and Set B can be clarified by companies.
   AI/ML model input: Alt 1): Only L1-RSRP measurement based on Set B; Alt.2): L1-RSRP measurement based on Set B and assistance information; Alt.
   3): CIR based on Set B; Alt. 4): L1-RSRP measurement based on Set B and the corresponding DL Tx and/or Rx beam ID.
BM-Case2: Temporal Downlink beam prediction for Set A of beams based on the historic measurement results of Set B of beams
   Consider: Alt. 1): AI/ML model training and inference at NW side. Alt. 2): AI/ML model training and inference at UE side.
   Consider: Alt. i): Set A and Set B are different (Set B is NOT a subset of Set A). Alt. ii): Set B is a subset of Set A (Set A and Set B are not the same). Alt. iii): Set A and Set B are the same.
   AI/ML model input: measurement results of K (K 1) latest measurement instances with the following alternatives: Alt. 1): Only L1-RSRP measurement based on Set B; Alt 2): L1-RSRP measurement based on Set B and assistance information; Alt. 3): L1-RSRP measurement based on Set B and the corresponding DL Tx and/or Rx beam ID.
   [AI/ML model output]: F predictions for F future time instances, where each prediction is for each time instance. At least F=1.

Set B is a set of beams whose measurements are taken as inputs of the AI/ML model.

Note: Beams in Set A and Set B can be in the same Frequency Range.

For both sub-use cases, the following alternatives are studied for the predicted beams:
Alt.1: DL Tx beam prediction
Alt.2: DL Rx beam prediction (deprioritized)
Alt.3: Beam pair prediction (a beam pair consists of a DL Tx beam and a corresponding DL Rx beam)

Note: DL Rx beam prediction may or may not have spec impact.

The following alternatives for [AI/ML model output] are defined:
Alt.1: Tx and/or Rx Beam ID(s) and/or the predicted L1-RSRP of the N predicted DL Tx and/or Rx beams
   e.g., N predicted beams can be the top-N predicted beams
Alt.2: Tx and/or Rx Beam ID(s) of the N predicted DL Tx and/or Rx beams and other information
   e.g., N predicted beams can be the top-N predicted beams
Alt.3: Tx and/or Rx Beam angle(s) and/or the predicted L1-RSRP of the N predicted DL Tx and/or Rx beams
   e.g., N predicted beams can be the top-N predicted beams

It is noted that it is up to companies to provide other alternative(s). Beam ID is only used for discussion purposes. All the outputs are “nominal” and only for discussion purpose.

Values of N is up to each company. All of the outputs in the above alternatives may vary based on whether the AI/ML model inference is at UE side or gNB side. The Top-N beam IDs might have been derived via post-processing of the ML-model output.

### AI Based Positioning Accuracy Enhancement

The following are selected as representative sub-use cases:
Direct AI/ML positioning:
   AI/ML model output: UE location,
   e.g., fingerprinting based on channel observation as the input of AI/ML model.
AI/ML assisted positioning:
   AI/ML model output: new measurement and/or enhancement of existing measurement,
   e.g., LOS/NLOS identification, timing and/or angle of measurement, likelihood of measurement.

More specifically, the following Cases are considered for the study:
Case 1: UE-based positioning with UE-side model, direct AI/ML or AI/ML assisted positioning,
Case 2a: UE-assisted/LMF-based positioning with UE-side model, AI/ML assisted positioning,
Case 2b: UE-assisted/LMF-based positioning with LMF-side model, direct AI/ML positioning,
Case 3a: NG-RAN node assisted positioning with gNB-side model, AI/ML assisted positioning,
Case 3b: NG-RAN node assisted positioning with LMF-side model, direct AI/ML positioning.

It is to be understood that the examples of AI/ML information and AI/ML based operations are listed only for illustration without any limitations. Some other examples are also applied and will not be listed herein.

In some implementations, an AI/ML model may be deployed at a gNB DU. For example, the gNB DU may train the AI model may itself. For example, the gNB DU may obtain a well-trained AI model from an operation administration maintenance (OAM), where the gNB CU may know the AI model or may not know the AI model. For example, the gNB DU may obtain a well-trained AI model from the gNB CU.

Since it is the gNB DU that is responsible for physical layer operation from network point of view, an LCM for an AI model usage may be performed at the gNB DU, however, how to assist the LCM needs to be further studied.

Embodiments of the present disclosure provide a solution for assistance information provision. In some embodiments, the first network unit may transmit, to a second network unit, assistance information for an LCM associated with an AI/ML based operation. Accordingly, the second network unit may perform the LCM based on the assistance information. In some embodiments, the first network unit may further receive a message which is related to the assistance information from the second network unit, e.g., the message may include an indication of AI/ML information in use at the second network unit or at a UE. Therefore, the assistance information may be provided from the first network unit to the second network unit, and thus an LCM procedure at the second network unit may be assisted. Principles and implementations of the present disclosure will be described in detail below with reference to the figures.

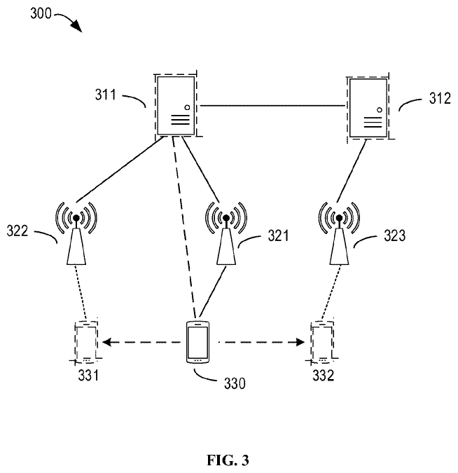

FIG. 3 illustrates a schematic diagram of an example communication network 300 in which some embodiments of the present disclosure can be implemented. As shown in FIG. 3, the communication network 300 includes a gNB CU 311 and a gNB CU 312. The communication network 300 further includes a gNB DU 321 and a gNB DU 322 connected to the gNB CU 311. The gNB DU 321 may server for the UE 330, that is, the gNB DU 321 is a serving gNB DU of the UE 330. The communication network 300 further includes a gNB DU 323 connected to the gNB CU 312. For ease of description, the gNB CU and the gNB DU may be referred to as a CU and a DU respectively.

As shown in FIG. 3, the gNB DU 321 may server for the UE 330. In some implementations, the UE 330 may be handed over (or switch) to another gNB.

In some examples, the handover may be an intra-gNB handover, that is, a source gNB DU and a target gNB DU are connected to a same gNB CU. In some examples, the intra-gNB handover may also be referred to as an intra-gNB-CU handover. For example, as shown in FIG. 3, the UE 330 may move to a location 331, and handed over to the gNB DU 322. In this case, the gNB DU 321 is a source gNB DU, and the gNB DU 322 is a target gNB DU.

In some examples, the handover may be an inter-gNB handover, that is, a source gNB DU and a target gNB DU are connected to different gNB CUs. In some examples, the inter-gNB handover may also be referred to as an inter-gNB-CU handover. For example, as shown in FIG. 3, the UE 330 may move to a location 332, and handed over to the gNB DU 323. In this case, the gNB CU 311 is a source gNB CU, the gNB DU 321 is a source gNB DU, the gNB CU 312 is a target gNB CU, and the gNB DU 323 is a target gNB DU.

It is to be understood that the numbers of devices and their connection relationships and types shown in FIG. 3 are only for the purpose of illustration without suggesting any limitation. The communication network 300 may include any suitable numbers of devices adapted for implementing embodiments of the present disclosure. For example, there may be more than one UE connected to the serving gNB DU 321. For example, there may be more gNB DUs connected to the gNB CU 311 or 312. For example, there may be another UE connected to the gNB DU 322 or the gNB DU 323.

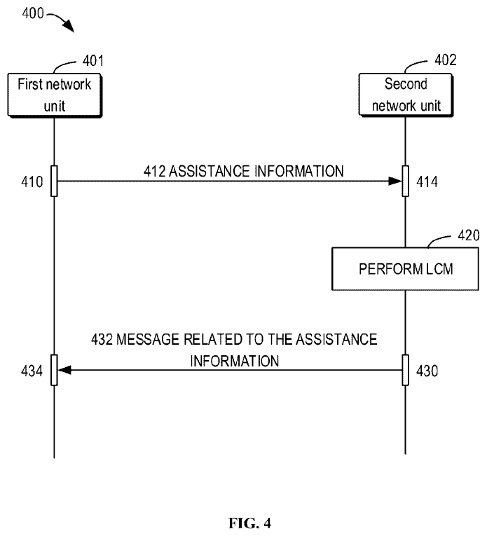

FIG. 4 illustrates an example of a process flow 400 in accordance with some example embodiments of the present disclosure. The process flow 400 may involve a first network unit 401 and a second network unit 402. The process flow 400 may be applied to the communication network 300 with reference to FIG. 3, for example, the first network unit 401 may be the gNB CU 311 and the second network unit 402 may be the gNB DU 321 in FIG. 3. It would be appreciated that the process flow 400 may be applied to other communication scenarios, which will not be described in detail.

The first network unit 401 transmits 410 assistance information 412 to the second network unit 402. In some embodiments, the assistance information 412 may be used for assisting LCM at the second network unit 402.

In some implementations, the assistance information 412 may indicate a suggestion regarding whether using AI or ML information to serve the UE. In some examples, the first network unit 401 may make the suggestion based on information aware by the first network unit 401. In some examples, the suggestion may suggest to use or not use the AI/ML information to serve the UE.

For example, since the AI/ML based method may be good to solve non-linear or non-deterministic problem, the assistance information 412 may include a suggestion that suggests to use the AI/ML information serve the UE(s), e.g., one or more concerned UEs.

For example, in case the UE environment and moving pattern is deterministic, e.g., a moving car on a highway with an almost fixed speed or a device that is rather stationary, since the AI/ML based method may cost extra effort ant computing power without additional gain compared to a conventional method, the assistance information 412 may include a suggestion that suggests to not use the AI/ML information serve the UE(s), e.g., one or more concerned UEs.

In some implementations, the assistance information 412 may indicate suggested UE side or network side AI/ML information to be activated or deactivated. In some examples, the first network unit 401 may determine one or more AI/ML features/functionalities/models and suggests the second network unit 402 to activate (or deactivate) the determined one or more AI/ML features/functionalities/models to serve the UE(s), e.g., one or more concerned UEs.

In some examples, some AI/ML features/functionalities/models may be dependent on a UE moving pattern and/or UE moving velocity. For example, the first network unit 401 may determine a UE moving pattern and/or a UE moving velocity, and the first network unit 401 may filter out multiple AI/ML features/functionalities/models that are suitable by considering the UE moving pattern and/or UE moving velocity. For example, the assistance information 412 may include an indication of the multiple AI/ML features/functionalities/models (such as a list thereof). In some embodiments, the second network unit 402 may select or activate at least one AI/ML feature/functionality/model from the multiple AI/ML features/functionalities/models indicated by the assistance information 412.

In some example embodiments, the suggestion and/or the suggested AI/ML information is determined based on available AI/ML information at the second network unit 402 or at the UE.

In some examples, the second network unit 402 may transmit a first indication to the first network unit 401, where the first indication may indicate a list of available AI/ML information at the second network unit 402. In some examples, the first indication may indicate a list of available gNB DU side AI/ML features/functionalities/models. For example, the first indication may be carried in a first message which is transmitted via an F1AP interface.

In some examples, the list of available AI/ML information at the second network unit 402 indicated by the first indication may be not UE specific, that is, the available AI/ML information at the second network unit 402 may be applied to multiple UEs as long as appropriate. In this case, the first message which includes the first indication is a non-UE associated message.

For example, the available AI/ML information at the second network unit 402 includes available gNB DU side AI/ML features, and the second network unit 402 (i.e., the gNB DU) may support CSI compression, CSI prediction, beam prediction, or positioning estimation.

For example, the available AI/ML information at the second network unit 402 includes available gNB DU side AI/ML functionalities, and the second network unit 402 (i.e., the gNB DU) may support CSI/beam spatial prediction if the UE is moving speed is below a threshold (such as 100 km/h) and in UMi environment.

For example, the available AI/ML information at the second network unit 402 includes available gNB DU side AI/ML models, and the second network unit 402 (i.e., the gNB DU) may support making beam prediction of SSB set A based on the measurement of SSB set B, where the SSB set A and the SSB set B represent different sets of beams.

In some embodiments, the first network unit 401 may determine the suggested network side (i.e., gNB DU side) AI/ML information to be activated (or deactivated) based on the first indication.

In some examples, the available gNB DU side AI/ML features/functionalities/models may be deployed by the OAM, and the first network unit 401 is aware of the available gNB DU side AI/ML features/functionalities/models, e.g., based on a configuration from the OAM. In some embodiments, the first network unit 401 may determine the suggested network side (i.e., gNB DU side) AI/ML information to be activated (or deactivated) based on the configuration from the OAM.

In some examples, the UE may transmit a second indication to the first network unit 401, where the second indication may indicate a list of available AI/ML information at the UE. In some examples, the second indication may indicate a list of available UE side AI/ML features/functionalities/models. For example, the second indication may be carried in an RRC message.

In some embodiments, the first network unit 401 may determine the suggested UE side AI/ML information to be activated (or deactivated) based on the second indication.

In some implementations, the assistance information 412 may indicate some information that aware by the first network unit 401. In some implementations, the assistance information 412 may further indicate one or more of: an expected arrival time of the UE from the second network unit 402 to a third network unit, an expected moving state of the UE, where the expected moving state is stationary or mobile, an expected activity time of the UE in an RRC connected state, an expected idle time of the UE in an RRC inactive state or an RRC idle state, whether the UE is a cell edge UE, a moving velocity of the UE, or a moving direction of the UE.

In some examples, the UE may be handed over from the second network unit 402 to a third network unit (such as a target gNB DU), and the first network unit 401 may predict or estimate an expected time interval between the handover.

In some examples, the first network unit 401 may determine whether the UE is an active UE or a stationary UE. For example, core network (CN) assisted RAN parameters tuning information element (IE) obtain from an access and mobility management function (AMF) may be used to determine whether the UE is a stationary UE. For example, the IE may be obtained via an NGAP interface from the AMF. For example, the UE may have a large amount of uplink or downlink traffics if the UE is an active UE.

In some examples, the first network unit 401 may obtain, from the AMF via the NGAP interface, an expected activity time of the UE in an RRC connected state, and/or an expected idle time of the UE in an RRC inactive state or an RRC idle state.

In some examples, the first network unit 401 may be able to predict the UE trajectory and the UE traffic. For example, the first network unit 401 may determine the moving velocity of the UE, the moving direction of the UE, and/or the moving trajectory of the UE.

In some implementations, the assistance information 412 may be carried in a second message (Msg2) via an F1AP interface from the first network unit 401 to the second network unit 402.

As mentioned above, the assistance information 412 may indicate suggested UE side AI/ML information. In some examples, the second message may include an RRC container which conveys the suggested UE side AI/ML information. In other words, an RRC container in the second message may include suggested UE side AI/ML feature/functionality/model.

On the other side of communication, the second network unit 402 receives 414 the assistance information 412. For example, the second network unit 402 may receive a second message which includes the assistance information 412. The second network unit 402 performs 420 an LCM procedure based on the assistance information 412.

In some implementations, the second network unit 402 may have a knowledge of the environment and/or expected UE behavior based on the assistance information 412. In some implementations, the second network unit 402 may make an LCM decision by taking the assistance information 412 into account.

In some implementations, the LCM decision may include activating, deactivating, switching, or falling back network side (i.e., gNB DU side) AI/ML information or UE side AI/ML information, for further physical layer operations, such as CSI feedback compression, CSI prediction, or beam prediction.

The second network unit 402 transmits 430 a message 432 which is related to the assistance information to the first network unit 401. In some implementations, the message 432 may be a third message.

In some implementations, the message 432 may include a response to the second message (including the assistance information 412). For example, the message 432 indicates an acknowledgement of the assistance information 412. In some examples, the assistance information 412 may not include a suggested AI/ML information, and the message 432 may not include information about AI/ML information in use.

In some implementations, the message 432 may include an indication of AI/ML information in use at the second network unit 402 or at the UE. In some examples, the assistance information 412 may indicate suggested network side (i.e., gNB DU side) AI/ML information, and the second network unit 402 may determine network side (i.e., gNB DU side) AI/ML information in use based on the assistance information 412. In some examples, the assistance information 412 may indicate suggested UE side AI/ML information, and the second network unit 402 may determine UE side AI/ML information in use based on the assistance information 412.

In some examples, the second network unit 402 may make a final LCM decision to determine the gNB DU side AI/ML information or the UE side AI/Ml information by considering the assistance information 412, such as one or more of: an expected arrival time of a UE from the second network unit to a third network unit, an expected moving state of the UE, where the expected moving state is stationary or mobile, an expected activity time of the UE in an RRC connected state, an expected idle time of the UE in an RRC inactive state or an RRC idle state, whether the UE is a cell edge UE, a moving velocity of the UE, or a moving direction of the UE. As such, the LCM decision made by the second network unit 402 may be proper for further physical layer operations.

On the other side of communication, the first network unit 401 receives 434 the message 432 which is related to the assistance information. In some examples, the first network unit 401 may receive an indication of gNB DU side AI/ML information in use or UE side AI/ML information in use. As such, the first network unit 401 may aware that the UE is served using the AI/ML information, and the first network unit 401 may further monitor the UE performance from a higher level point of view and give some further suggestions.

In some example embodiments, an ID, an index, or meta information may be used to identify the AI/ML information. In some examples, each AI/ML feature/functionality/model may be associated with an ID (or an index), and different AI/ML features/functionalities/models may have different IDs (or indexes). For instance, the associated ID may be implemented as a measurement ID. For example, the assistance information 412 may include an ID (or an index) to indicate suggested gNB DU side (or UE side) AI/ML information. For example, the message 432 may include another ID (or another index) to indicate the NB DU side (or UE side) AI/ML information in use. In some other examples, the meta information associated with the AI/ML information may be determined based on applicable conditions or configurations of the AI/ML information.

In some implementations, there has been an agreement on the ID or meta information of AI/ML information, as such, the communication between different network units can be guaranteed. For example, the ID or meta information of AI/ML information may be generated or determined by the first network unit 401 and be provided to the second network unit 402. As such, a coordination between the first network unit 401 and the second network unit 402 may identify the AI/ML information, i.e., the AI/ML feature/functionality/model. In some other implementations, the AI/ML information may be identified by another identification or information, the present disclosure does not limit this aspect.

In some example embodiments, each of the second message (including the assistance information 412) and the third message (being the message 432) may be a non-UE associated message or a UE associated message.

In some implementations, each of the second message and the third message is a UE associated message, in some examples, the process 400 may be regarded as a UE associated procedure. In some examples, the UE associated procedure may be implemented as one or: a UE Context Setup procedure, a UE Context Modification (gNB-CU initiated) procedure, a UE Context Modification Required (gNB-DU initiated) procedure or the like. In some examples, the UE associated procedure may be implemented as a new defined procedure over F1 interface, such as, an AI Management procedure, an AI Life Cycle Management procedure, an AI/ML Information Reporting Initiation procedure, a Data Collection Initiation procedure, or the like, the present disclosure does not limit this aspect.

In some examples, the second message may further include an ID of the UE, and the third message may further include the ID of the UE too. Take the UE 330 in FIG. 3 as an example, the assistance information 412 may indicate a suggestion regarding whether using AI or ML information to server the UE 330. For example, the assistance information 412 may indicate a suggested gNB DU side AI/ML information to serve the UE 330. For example, the assistance information 412 may indicate one or more of: an expected arrival time of the UE 330 between inter-DU handovers, an expected moving state of the UE 330, an expected activity time of the UE 330 in an RRC connected state, an expected idle time of the UE 330 in an RRC inactive state or an RRC idle state, whether the UE 330 is a cell edge UE, a moving velocity of the UE 330, or a moving direction of the UE 330. For example, the third message may include an indication of gNB DU side AI/ML information in use to serve the UE 330.

In some other implementations, each of the second message and the third message is a non-UE associated message, in some examples, the process 400 may be regarded as a non-UE associated procedure. In some examples, the non-UE associated procedure may be implemented as a new defined procedure over F1 interface, such as, an AI Management procedure, an AI Life Cycle Management procedure, an AI/ML Information Reporting Initiation procedure, a Data Collection Initiation procedure, or the like, the present disclosure does not limit this aspect.

In some examples, the second message may further include multiple IDs of concerned UEs, and the third message may further include the multiple IDs of concerned UEs too. In some examples, for each of the multiple concerned UEs, the second message and the third message may include information associated with a UE discussed above.

In some examples, an ID of a UE may be a UE F1AP ID which is assigned by the first network unit 401 (i.e., a gNB CU) or the second network unit 402 (i.e., gNB DU).

According to some embodiments described with reference to FIG. 4, the first network unit 401 may provide assistance information based on information that known by the gNB CU but not available at the gNB DU, and thus the first network unit 401 may assist the LCM at the second network unit 402. As such, the second network unit 402 may make a final LCM decision upon on the second network unit 402 based on the assistance information from the first network unit 401 and the knowledge of the physical layer performance and measurement known by the second network unit 402.

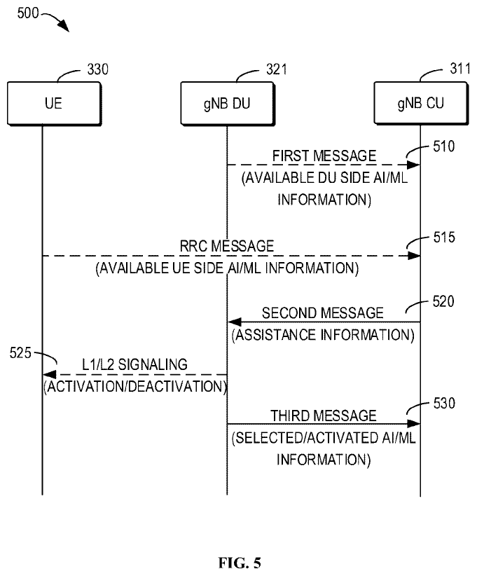

FIG. 5 illustrates another example of a process flow 500 of assistance information provision in accordance with some example embodiments of the present disclosure. The process flow 500 may involve the gNB CU 311, the gNB DU 321, and the UE 330 in FIG. 3. In some examples, the process flow 500 may be a non-mobility scenario. It would be appreciated that the process flow 500 is discussed with reference to FIG. 3, but the process flow 500 may also be applied to other communication scenarios, which will not be described in detail.

The gNB DU 321 transmits a first message to the gNB CU 311 at 510. In some examples, the first message may indicate available gNB DU side AI/ML information. For example, the first message may indicate one or more available gNB DU side AI/ML features/functionalities/models. For example, the first message may be a non-UE associated message, and the first message may be transmitted via the F1AP interface. In some examples, the first message may include multiple IDs of multiple UEs that the available gNB DU side AI/ML information can serve for. In some other examples, the first message may not include any UE ID to implicitly indicate that the available gNB DU side AI/ML information may serve for all UEs connected to the gNB DU 321.

It is to be understood that in case the available gNB DU side AI/ML information is deployed by the OAM and the gNB CU 311 has known the available gNB DU side AI/ML information, the step 510 in FIG. 5 can be omitted.

The UE 330 transmits an RRC message to the gNB CU 311 at 515. In some examples, the RRC message may indicate available UE side AI/ML information. For example, the RRC message may indicate one or more available UE side AI/ML features/functionalities/models.

It is to be understood that in case there is no available UE side AI/ML information, the step 515 in FIG. 5 can be omitted.

The gNB CU 311 transmits a second message to the gNB DU 321 at 520, where the second message may include assistance information for an LCM at the gNB DU 321.

In some examples, the assistance information may indicate a suggestion whether using the available gNB DU side AI/ML information (indicated by the first message at 510 or obtained from OAM) for serving a specific UE (UE associated) or multiple UEs (non-UE associated). For example, the assistance information may indicate whether to activate or deactivate (enable or disable) the available gNB DU side AI/ML information for serving the specific UE (such as UE 330) or multiple UEs.

In some examples, the assistance information may indicate a suggestion whether using the available UE side AI/ML information (indicated by the RRC message at 515). For example, the assistance information may indicate whether to activate or deactivate (enable or disable) the available UE side AI/ML information.

In some examples, the assistance information may indicate a suggested gNB DU side AI/ML information for serving a specific UE (UE associated) or multiple UEs (non-UE associated). For example, the suggested gNB DU side AI/ML information may be selected or determined from the available gNB DU side AI/ML information (indicated by the first message at 510 or obtained from OAM).

In some examples, the assistance information may indicate a suggested UE side AI/ML information. For example, the suggested UE side AI/ML information may be selected or determined from the available UE side AI/ML information (indicated by the RRC message at 515). For example, the suggested UE side AI/ML information may be conveyed by an RRC container.

In some examples, the assistance information may include information about a moving pattern of the specific UE or multiple UEs. For example, information about a moving pattern of a UE may include one or more of: an expected arrival time of the UE from the second network unit 402 to a third network unit, an expected moving state of the UE, where the expected moving state is stationary or mobile, an expected activity time of the UE in an RRC connected state, an expected idle time of the UE in an RRC inactive state or an RRC idle state, whether the UE is a cell edge UE, a moving velocity of the UE, or a moving direction of the UE. For example, for the UE 330, the assistance information may indicate that the UE 330 is stationary, that is, the UE 330 is in a non-mobility scenario.

It is to be understood that some detailed description of the second message at 520 may refer to those discussed above with reference to assistance information 412 in FIG. 4, and thus will not be repeated herein.

The gNB DU 321 may determine gNB DU side AI/ML information in use and/or UE side AI/ML information in use. In some examples, the gNB DU 321 may determine specific gNB DU side AI/ML information for serving a specific UE (such as the UE 330) or for serving multiple UEs. For example, the gNB DU 321 may activate (or enable) or deactivate (or disable) a specific gNB DU side AI/ML feature/functionality/model for serving the UE 330.

In some examples, the gNB DU 321 may determine UE side AI/ML information in use. For example, the gNB DU 321 may activate (or enable) or deactivate (or disable) a specific UE side AI/ML feature/functionality/model. As shown in FIG. 5, the gNB DU 32 may inform the UE 330 to activate (or enable) or deactivate (or disable) a specific UE side AI/ML feature/functionality/model by using L1/L2 signalling at 525.

The gNB DU 321 transmits a third message to the gNB CU 31t at 530. In some examples, the third message may include an indication of gNB DU side (and/or UE side) AI/ML information in use.

For example, the third message may indicate activated (or enabled) gNB DU side AI/ML information or activated (or enabled) UE side AI/ML information. For example, the third message may indicate a list of UE side features/functionalities/models activated (or enabled). For example, the third message may indicate a list of gNB DU side features/functionalities/models activated (or enabled).

It is to be understood that that some detailed description of the third message at 530 may refer to those discussed above with reference to the message 432 in FIG. 4, and thus will not be repeated herein.

According to some embodiments described with reference to FIG. 5, while the UE is in a non-mobility scenario, the gNB CU may provide assistance information to the gNB DU, and accordingly gNB DU may effectively select or active gNB DU side or UE side AI/ML information. In addition, the gNB DU may inform the gNB CU of the activated AI/ML information.

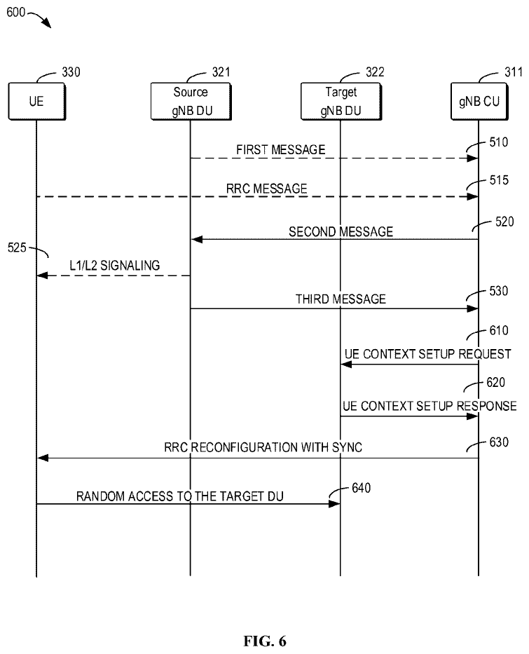

FIG. 6 illustrates an example of a process flow 600 of an intra-gNB-CU handover in accordance with some example embodiments of the present disclosure. The process flow 600 may involve the gNB CU 311, the gNB DU 321, the gNB DU 322, and the UE 330 in FIG. 3. In some examples, the process flow 600 may be an intra-CU handover scenario.

It would be appreciated that the process flow 600 is discussed with reference to FIG. 3, but the process flow 600 may also be applied to other communication scenarios, which will not be described in detail.

As shown in FIG. 6, the process flow 600 may include some or all of the steps 510 to 530, which may refer to those discussed with reference to FIG. 5, and thus will not be repeated herein.

The process flow 600 relates to a handover of the UE 330 which may be handed over from the gNB DU 321 to the gNB DU 322. In this case, the gNB DU 321 may be a source gNB DU, and the gNB DU 322 may be a target gNB DU. Since both the gNB DU 321 and the gNB DU 322 are connected to the same gNB CU 311, the handover may be regarded as an intra-gNB handover, which may be called as an intra gNB CU handover, an intra CU handover, an intra-CU inter-DU handover, or the like, the present disclosure does not limit this aspect.

The gNB CU 311 transmits a UE context setup request to the gNB DU 322 (i.e., the target gNB DUI) at 610. In some examples, the gNB CU 311 may trigger the intra-CU inter-DU handover and may send the UE CONTEXT SETUP REQUEST to the target gNB DU. For example, the U context setup request may be regarded as a handover request.

In some examples, the UE context setup request may include information that included in the third message. For example, the UE context setup request may include an indication of source gNB DU side (and/or UE side) AI/ML information in use. For example, the UE context setup request may indicate a list of UE side features/functionalities/models activated (or enabled). For example, the UE context setup request may indicate a list of source gNB DU side features/functionalities models activated (or enabled).

In some implementations, the UE context setup request may include the assistance information that provided to the source gNB DU 321 at 520.

For example, an example implementation of the UE context setup request may be shown at Table 2 below, where presence “0” represents optional. It is to be understood that the example is shown only for illustration without any limitation.

TABLE 2

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| type | | | | | | |
| gNB-CU | M | | 9.3.1.4 | | YES | reject |
| UE F1AP | | | | | | |
| ID | | | | | | |
| gNB-DU | O | | 9.3.1.5 | | YES | ignore |
| UE F1AP | | | | | | |
| ID | | | | | | |
| SpCell | M | | NR CGI | Special | YES | reject |
| ID | | | 9.3.1.12 | Cell as | | |
| | | | | defined | | |
| | | | | in TS | | |
| | | | | 38.321 | | |
| | | | | [16]. | | |
| | | | | For | | |
| | | | | handover | | |
| | | | | case, | | |
| | | | | this IE | | |
| | | | | is | | |
| | | | | considered | | |
| | | | | as | | |
| | | | | target | | |
| | | | | cell. | | |
| . . . | . . . | . . . | . . . | . . . | . . . | . . . |
| AI | | | | | | |
| Management | | | | | | |
| Assisting | | | | | | |
| Information | | | | | | |
| > Use of | O | | ENUMERATED | | | |
| AI | | | (true, . . . , | | | |
| | | | false) | | | |
| > | | | | | | |
| Suggested | | | | | | |
| AI List | | | | | | |
| >>AI | O | 1 .. | | | | |
| feature | | <maxnoofAIfeatures> | | | | |
| index | | | | | | |
| >>AI | O | 1 .. | | | | |
| functionality | | <maxnoofAIfunction- | | | | |
| index | | alities> | | | | |
| >>AI | O | 1 .. | | | | |
| model | | <maxnoofAIindexes> | | | | |
| index | | | | | | |

The gNB DU 322 transmits a UE context setup response to the gNB CU 311 at 620. In some examples, the gNB DU 322 (i.e., the target gNB DU) may accept the UE CONTEXT SETUP REQUEST and send the UE CONTEXT SETUP RESPONSE.

In some examples, the gNB DU 322 may select or activate gNB DU side (target gNB DU side) AT/MVL information or UE side AI/ML information, e.g., based on the UE context setup request. It is to be understood the process is similar with that performed by the source gNB DU 321 for determining the third message, and thus will not be repeated herein.

In some examples, the UE context setup response may include similar information as the third message. For example, the UE context setup response may indicate activated (or enabled) target gNB DU side AI/ML information or activated (or enabled) UE side AI/ML information, which is activated by the gNB DU 322. For example, the UE context setup response may indicate a list of UE side features/functionalities/models activated (or enabled) by the gNB DU 322. For example, the UE context setup response may indicate a list of gNB DU side features/functionalities/models activated (or enabled) by the gNB DU 322.

The gNB CU 311 may further transmit a handover command to the UE 330. As shown in FIG. 6, an RRCReconfiguration message with reconfiguration WithSync may be sent to the UE 330 at 630. In some examples, the handover command (such as the RRCReconfiguration message) may instruct the UE 330 to activate (or enable) the UE side AI/ML information that indicated in the UE context setup response.

For example, the UE context setup response may indicate a specific UE side AI/ML information activated by the gNB DU 322, and the handover command (such as the RRCReconfiguration message) may instruct the UE 330 to activate (or enable) the specific UE side AI/ML information.

In some implementations, the UE 330 may activate a certain existing AI/ML feature/functionality/model based on the handover command (such as the RRCReconfiguration message), while the UE 330 executing a handover and random access to the target gNB DU 322 at 640. For example, the activated UE side AI/ML feature/functionality/model may be used or executed by the UE 330.

According to some embodiments described with reference to FIG. 6, during an intra-CU inter-DU mobility, the gNB CU may inform the target gNB DU of the source gNB DU side or UE side AI/ML information in use, and accordingly the target gNB DU may make a further decision by taking the information from the gNB CU into account. For example, the target gNB DU may use the same AI/ML information as that used by the source gNB DU or may use different AI/ML information. In some examples, a continuity of using the AI/ML information between DUs during a handover can be guaranteed.

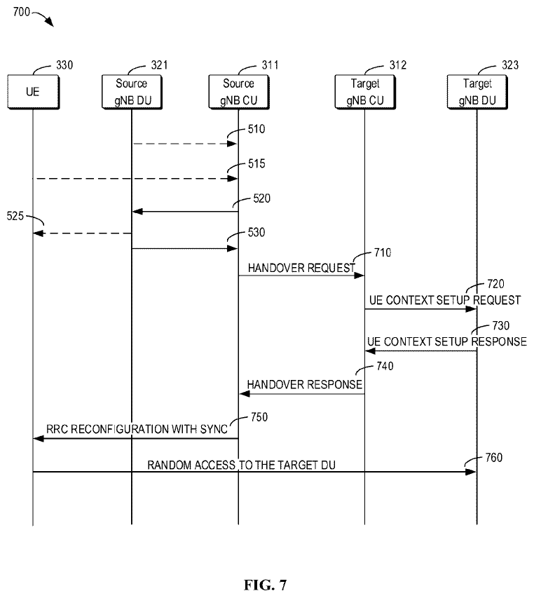

FIG. 7 illustrates an example of a process flow 700 of an inter-gNB-CU handover in accordance with some example embodiments of the present disclosure. The process flow 700 may involve the gNB CU 311, the gNB CU 312, the gNB DU 321, the gNB DU 323, and the UE 330 in FIG. 3. In some examples, the process flow 700 may be an inter-CU handover scenario. It would be appreciated that the process flow 700 is discussed with reference to FIG. 3, but the process flow 700 may also be applied to other communication scenarios, which will not be described in detail.

As shown in FIG. 7, the process flow 700 may include some or all of the steps 510 to 530, which may refer to those discussed with reference to FIG. 5, and thus will not be repeated herein.

The process flow 700 relates to a handover of the UE 330 which may be handed over from the gNB DU 321 to the gNB DU 323. In this case, the gNB DU 321 may be a source gNB DU, and the gNB DU 323 may be a target gNB DU. Since the gNB DU 321 and the gNB DU 323 are connected to gNB CU 311 and gNB CU 312 respectively, the handover may be regarded as an inter-gNB handover, which may be called as an inter gNB CU handover, an inter CU handover, an inter-CU inter-DU handover, or the like, the present disclosure does not limit this aspect. In this case, the gNB CU 311 is a source gNB CU, and the gNB CU 312 is a target gNB CU.

The gNB CU 311 transmits a handover request to the gNB CU 312 at 710. In some examples, the gNB CU 311 may trigger the inter gNB CU handover and may send the HANDOVER REQUEST message to the target gNB CU.

In some examples, the handover request may include information that included in the third message. For example, the handover request may include an indication of source gNB DU side (and/or UE side) AI/ML information in use. For example, the handover request may indicate a list of UE side features/functionalities/models activated (or enabled). For example, the handover request may indicate a list of source gNB DU side features/functionalities/models activated (or enabled).

The gNB CU 312 transmits a UE context setup request to the gNB DU 323 (i.e., the target gNB DU) at 720. In some examples, the UE context setup request may include information that included in the handover request. In some examples, the target gNB CU 312 may forward the information (in the handover request from the source gNB CU 311) to the target gNB DU 323 through the UE context setup request.

The gNB DU 323 transmits a UE context setup response to the gNB CU 312 at 730. In some examples, the processes 720 and 730 are similar with the processes 610 and 620 that discussed in FIG. 6. In some examples, the UE context setup response may indicate activated (or enabled) target gNB DU side AI/ML information or activated (or enabled) UE side AI/ML information, which is activated by the gNB DU 323. For example, the UE context setup response may indicate a list of UE side features/functionalities/models activated (or enabled) by the gNB DU 323. For example, the UE context setup response may indicate a list of gNB DU side features/functionalities/models activated (or enabled) by the gNB DU 323.

The gNB CU 312 transmits a handover response to the gNB CU 311 at 740. In some examples, the target gNB CU 312 may accept the handover request and may transmit a handover request acknowledge to the source gNB CU 311. For example, the handover response may indicate a handover request acknowledgement. In some examples, the handover response may include information that included in the UE context setup response from the target gNB DU 323. For example, the handover response may indicate a list of UE side features/functionalities/models activated (or enabled) by the gNB DU 323; or may indicate a list of gNB DU side features/functionalities/models activated (or enabled) by the gNB DU 323.

The process flow 700 may further include steps 750 and 760, which are similar with steps 630 and 640 in FIG. 6 respectively. For ease of description, the details will not be repeated herein.

According to some embodiments described with reference to FIG. 7, during an inter-CU inter-DU mobility, the source gNB CU may inform the target gNB CU of the source gNB DU side or UE side AI/ML information in use, and accordingly the target gNB CU may forward the information to the target gNB DU; and accordingly the target gNB DU may make a further decision by taking the information from the gNB CU into account. For example, the target gNB DU may use the same AI/ML information as that used by the source gNB DU or may use different AI/ML information. In some examples, a continuity of using the AI/ML information between DUs during a handover can be guaranteed.

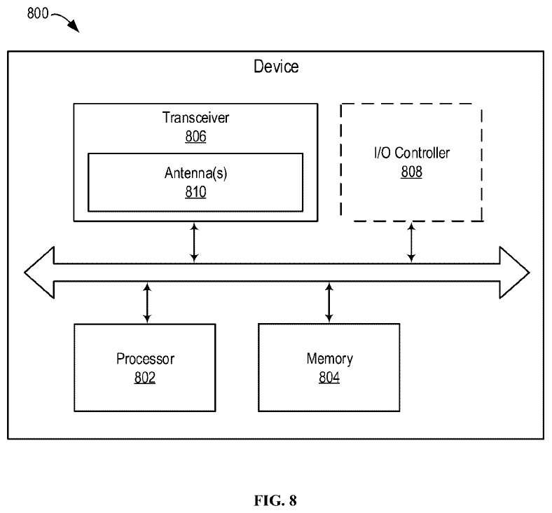

FIG. 8 illustrates an example of a device 800 that is suitable for implementing embodiments of the present disclosure. The device 800 may be an example of a network unit as described herein. The device 800 may support wireless communication with a gNB CU 311/312, the gNB DU 321/322/323, or any combination thereof. The device 800 may include components for bi-directional communications including components for transmitting and receiving communications, such as a processor 802, a memory 804, a transceiver 806, and, optionally, an I/O controller 808. These components may be in electronic communication or otherwise coupled (e.g., operatively, communicatively, functionally, electronically, electrically) via one or more interfaces (e.g., buses).

The processor 802, the memory 804, the transceiver 806, or various combinations thereof or various components thereof may be examples of means for performing various aspects of the present disclosure as described herein. For example, the processor 802, the memory 804, the transceiver 806, or various combinations or components thereof may support a method for performing one or more of the operations described herein.

In some implementations, the processor 802, the memory 804, the transceiver 806, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 802 and the memory 804 coupled with the processor 802 may be configured to perform one or more of the functions described herein (e.g., executing, by the processor 802, instructions stored in the memory 804).

For example, the processor 802 may support wireless communication at the device 800 in accordance with examples as disclosed herein. The processor 802 may be configured to operable to support a means for transmitting, to a second network unit, assistance information for an LCM associated with an AI/ML based operation; and means for receiving, from the second network unit, a message being related to the assistance information. The processor 802 may be configured to operable to support a means for receiving, from a first network unit, assistance information for an LCM associated with an AI/ML based operation; and means for transmitting, to the first network unit, a message being related to the assistance information. The processor 802 may be configured to operable to support a means for receiving, from a first network unit or a fourth network unit, a UE context setup request comprising AI/ML information in use at a second network unit or at a UE; and means for transmitting, to the first network unit or the fourth network unit, a UE context setup response comprising an activated AI/ML information. The processor 802 may be configured to operable to support a means for receiving, from a first network unit, a handover request comprising AI/ML information in use at a second network unit or at a UE; means for transmitting, to a third network unit, a UE context setup request comprising the AI/ML information in use at the second network unit or at the UE; means for receiving, from the third network unit, a UE context setup response comprising an activated AI/ML information being activated by the third network unit; and means for transmitting, to the first network unit, a handover response comprising the activated AI/ML information.

The processor 802 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 802 may be configured to operate a memory array using a memory controller. In some other implementations, a memory controller may be integrated into the processor 802. The processor 802 may be configured to execute computer-readable instructions stored in a memory (e.g., the memory 804) to cause the device 800 to perform various functions of the present disclosure.

The memory 804 may include random access memory (RAM) and read-only memory (ROM). The memory 804 may store computer-readable, computer-executable code including instructions that, when executed by the processor 802 cause the device 800 to perform various functions described herein. The code may be stored in a non-transitory computer-readable medium such as system memory or another type of memory. In some implementations, the code may not be directly executable by the processor 802 but may cause a computer (e.g., when compiled and executed) to perform functions described herein. In some implementations, the memory 804 may include, among other things, a basic I/O system (BIOS) which may control basic hardware or software operation such as the interaction with peripheral components or devices.

The I/O controller 808 may manage input and output signals for the device 800. The I/O controller 808 may also manage peripherals not integrated into the device M02. In some implementations, the I/O controller 808 may represent a physical connection or port to an external peripheral. In some implementations, the I/O controller 808 may utilize an operating system such as iOS®, ANDROID®, MS-WINDOWS®, OS/2®, UNIX®, LINUX®, or another known operating system. In some implementations, the I/O controller 808 may be implemented as part of a processor, such as the processor 806. In some implementations, a user may interact with the device 800 via the I/O controller 808 or via hardware components controlled by the I/O controller 808.

In some implementations, the device 800 may include a single antenna 810. However, in some other implementations, the device 800 may have more than one antenna 810 (i.e., multiple antennas), including multiple antenna panels or antenna arrays, which may be capable of concurrently transmitting or receiving multiple wireless transmissions. The transceiver 806 may communicate bi-directionally, via the one or more antennas 810, wired, or wireless links as described herein. For example, the transceiver 806 may represent a wireless transceiver and may communicate bi-directionally with another wireless transceiver. The transceiver 806 may also include a modem to modulate the packets, to provide the modulated packets to one or more antennas 810 for transmission, and to demodulate packets received from the one or more antennas 810. The transceiver 806 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 810 for transmitting the amplified signal into the air or wireless medium.

A receive chain may be configured to receive signals (e.g., control information, data, packets) over a wireless medium. For example, the receive chain may include one or more antennas 810 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

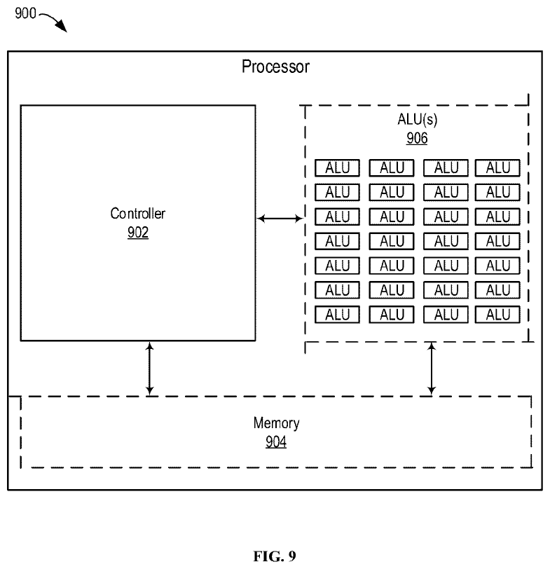

FIG. 9 illustrates an example of a processor 900 that is suitable for implementing some embodiments of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, such as L1/L2/L3 cache. Additionally, or alternatively, the processor 900 may optionally include one or more arithmetic-logic units (ALUs) 900. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 900 may be configured to support various operations in accordance with examples as described herein. In some implementations, the one or more ALUs 900 may reside within or on a processor chipset (e.g., the processor 900). In some other implementations, the one or more ALUs 900 may reside external to the processor chipset (e.g., the processor 900). One or more ALUs 900 may perform one or more computations such as addition, subtraction, multiplication, and division on data. For example, one or more ALUs 900 may receive input operands and an operation code, which determines an operation to be executed. One or more ALUs 900 be configured with a variety of logical and arithmetic circuits, including adders, subtractors, shifters, and logic gates, to process and manipulate the data according to the operation. Additionally, or alternatively, the one or more ALUs 900 may support logical operations such as AND, OR, exclusive-OR (XOR), not-OR (NOR), and not-AND (NAND), enabling the one or more ALUs 900 to handle conditional operations, comparisons, and bitwise operations.

The processor 900 may support wireless communication in accordance with examples as disclosed herein. The processor 900 may be configured to or operable to support a means for operations described in some embodiments of the present disclosure.

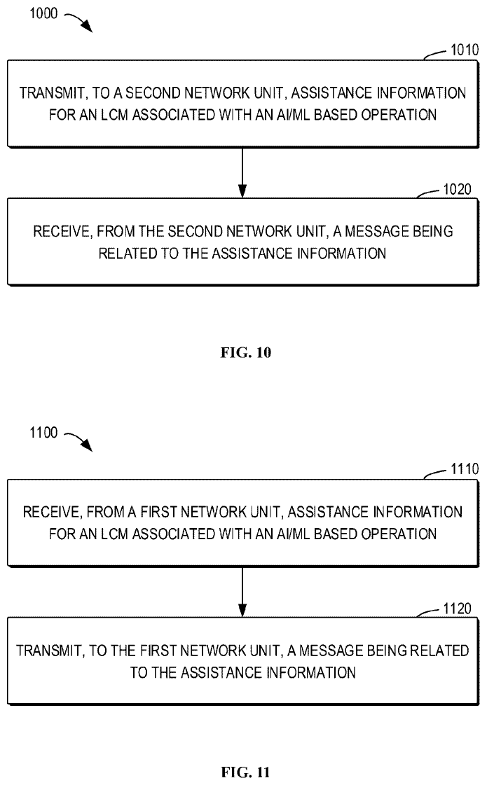

FIG. 10 illustrates a flowchart of a method 1000 performed by a first network unit in accordance with aspects of the present disclosure. The operations of the method 1000 may be implemented by a device or its components as described herein. For example, the operations of the method 1000 may be performed by a gNB CU 311 in FIG. 3. In some implementations, the device may execute a set of instructions to control the function elements of the device to perform the described functions. Additionally, or alternatively, the device may perform aspects of the described functions using special-purpose hardware.

At 1010, the method may include transmitting, to a second network unit, assistance information for an LCM associated with an AI/ML based operation. The operations of 1010 may be performed in accordance with examples as described herein. In some implementations, aspects of the operations of 1010 may be performed by a gNB CU 311 as described with reference to FIG. 3.

At 1020, the method may include receiving, from the second network unit, a message being related to the assistance information. The operations of 1020 may be performed in accordance with examples as described herein. In some implementations, aspects of the operations of 1020 may be performed by a gNB CU 311 as described with reference to FIG. 3.

In some implementations, a suggestion regarding whether using AI or ML information to serve a UE, suggested UE side AI or ML information to be activated or deactivated, or suggested network side AI or ML information to be activated or deactivated.

In some implementations, the assistance information indicates at least one of: an expected arrival time of a UE from the second network unit to a third network unit, an expected moving state of the UE, wherein the expected moving state is stationary or mobile, an expected activity time of the UE in an RRC connected state, an expected idle time of the UE in an RRC inactive state or an RRC idle state, whether the UE is a cell edge UE, a moving velocity of the UE, or a moving direction of the UE.

In some implementations, the message comprises an indication of AL or ML information in use at the second network unit or at a UE, wherein the AI or ML information in use is determined based on the assistance information.

In some implementations, the first network unit receives, from the second network unit, a first indication of AI or ML information to be used at the second network unit.

In some implementations, the first network unit receives, from a UE, a second indication of AI or ML information to be used at the UE.

In some implementations, the first network unit is a CU and the second network unit is a DU.

In some implementations, the first network unit transmits, to a third network unit, a UE context setup request comprising the AI or ML information in use at the second network unit or at a UE; and receives, from the third network unit, a UE context setup response comprising an activated AI or ML information.

In some implementations, the second network unit is a source DU, the third network unit is a target DU, and the first network unit is a CU.

In some implementations, the first network unit transmits, to a fourth network unit, a handover request comprising the AI or ML information in use at the second network unit or at a UE; and receives, from the fourth network unit, a handover response comprising an activated AI or ML information being activated by a third network unit.

In some implementations, the fourth network unit is a target CU and the third network unit is a target DU.

In some implementations, an ID, an index, or meta information is used for identifying the AI or ML information.

In some implementations, the AI or ML information comprises one of: one or more AI or ML features, one or more AI or ML functionalities, or one or more AI or ML models.

In some implementations, the AI or ML based operation comprises one of: an AI or ML based CSI enhancement, an AI or ML based beam management, or an AI or ML based positioning accuracy enhancement.

FIG. 11 illustrates a flowchart of a method 1100 performed by a second network unit in accordance with aspects of the present disclosure. The operations of the method 1100 may be implemented by a device or its components as described herein. For example, the operations of the method 1100 may be performed by a gNB DU 321. In some implementations, the device may execute a set of instructions to control the function elements of the device to perform the described functions. Additionally, or alternatively, the device may perform aspects of the described functions using special-purpose hardware.

At 1110, the method may include receiving, from a first network unit, assistance information for an LCM associated with an AI/ML based operation. The operations of 1110 may be performed in accordance with examples as described herein. In some implementations, aspects of the operations of 1110 may be performed by a gNB DU 321.

At 1120, the method may include transmitting, to the first network unit, a message being related to the assistance information. The operations of 1120 may be performed in accordance with examples as described herein. In some implementations, aspects of the operations of 1120 may be performed by a gNB DU 321.

In some implementations, the assistance information indicates at least one of: a suggestion regarding whether using AI or ML information to serve a UE, suggested UE side AI or ML information to be activated or deactivated, or suggested network side AL or ML information to be activated or deactivated.

In some implementations, the assistance information indicates at least one of: an expected arrival time of a UE from the second network unit to a third network unit, an expected moving state of the UE, wherein the expected moving state is stationary or mobile, an expected activity time of the UE in an RRC connected state, an expected idle time of the UE in an RRC inactive state or an RRC idle state, whether the UE is a cell edge UE, a moving velocity of the UE, or a moving direction of the UE.

In some implementations, the second network unit performs the LCM based on the assistance information to determine AI or ML information in use at the second network unit or at a UE; and wherein the message comprises an indication of AI or ML information in use at the second network unit or at the UE.

In some implementations, the second network unit transmits, to the first network unit, a first indication of AI or ML information to be used at the second network unit.

In some implementations, the first network unit is a CU and the second network unit is a DU.

In some implementations, an ID, an index, or meta information is used for identifying the AI or ML information.

In some implementations, the AI or ML information comprises one of: one or more AI or ML features, one or more AI or ML functionalities, or one or more AI or ML models.

In some implementations, the AI or ML based operation comprises one of: an AI or ML based CSI enhancement, an AI or ML based beam management, or an AI or ML based positioning accuracy enhancement.

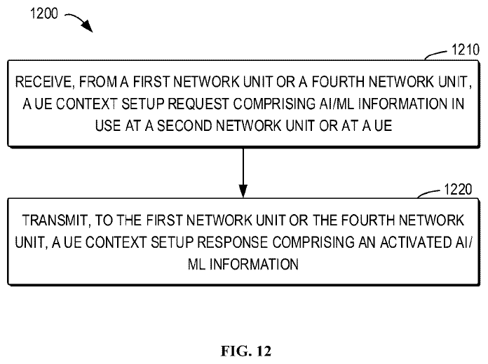

FIG. 12 illustrates a flowchart of a method 1200 performed by a third network unit in accordance with aspects of the present disclosure. The operations of the method 1200 may be implemented by a device or its components as described herein. For example, the operations of the method 1200 may be performed by a gNB DU 322 or 323. In some implementations, the device may execute a set of instructions to control the function elements of the device to perform the described functions. Additionally, or alternatively, the device may perform aspects of the described functions using special-purpose hardware.

At 1210, the method may include receiving, from a first network unit or a fourth network unit, a UE context setup request comprising AI/ML information in use at a second network unit or at a UE. The operations of 1210 may be performed in accordance with examples as described herein. In some implementations, aspects of the operations of 1210 may be performed by a gNB CU DU 322 or 323.

At 1220, the method may include transmitting, to the first network unit or the fourth network unit, a UE context setup response comprising an activated AI/ML information. The operations of 1220 may be performed in accordance with examples as described herein. In some implementations, aspects of the operations of 1220 may be performed by a gNB CU DU 322 or 323.

In some implementations, the first network unit is a source CU, the second network unit is a source DU, the third network unit is a target DU, and the fourth network unit is a target CU.

In some implementations, an ID, an index, or meta information is used for identifying the AI or ML information.

In some implementations, the AI or ML information comprises one of: one or more AI or ML features, one or more AI or ML functionalities, or one or more AI or ML models.

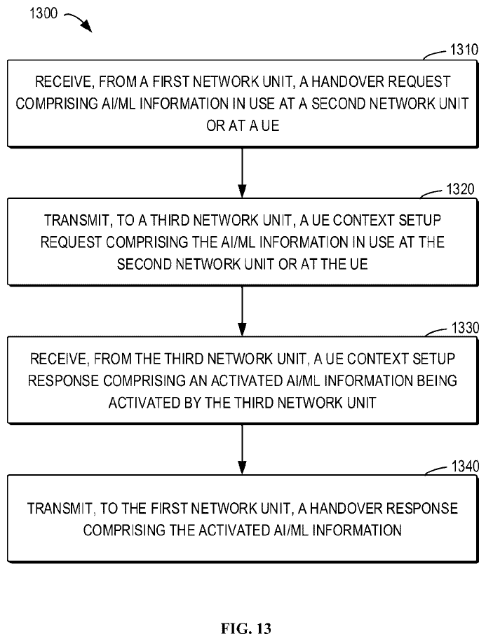

FIG. 13 illustrates a flowchart of a method 1300 performed by a fourth network unit in accordance with aspects of the present disclosure. The operations of the method 1300 may be implemented by a device or its components as described herein. For example, the operations of the method 1300 may be performed by a gNB CU 312. In some implementations, the device may execute a set of instructions to control the function elements of the device to perform the described functions. Additionally, or alternatively, the device may perform aspects of the described functions using special-purpose hardware.

At 1310, the method may include receiving, from a first network unit, a handover request comprising AI/ML information in use at a second network unit or at a UE. The operations of 1310 may be performed in accordance with examples as described herein. In some implementations, aspects of the operations of 1310 may be performed by a gNB CU 312.

At 1320, the method may include transmitting, to a third network unit, a UE context setup request comprising the AI/ML information in use at the second network unit or at the UE. The operations of 1320 may be performed in accordance with examples as described herein. In some implementations, aspects of the operations of 1320 may be performed by a gNB CU 312.

At 1330, the method may include receiving, from the third network unit, a UE context setup response comprising an activated AI/ML information being activated by the third network unit. The operations of 1330 may be performed in accordance with examples as described herein. In some implementations, aspects of the operations of 1330 may be performed by a gNB CU 312.

At 1340, the method may include transmitting, to the first network unit, a handover response comprising the activated AI/ML information. The operations of 1340 may be performed in accordance with examples as described herein. In some implementations, aspects of the operations of 1340 may be performed by a gNB CU 312.

In some implementations, the first network unit is a source CU, the second network unit is a source DU, the third network unit is a target DU, and the fourth network unit is a target CU.

In some implementations, an ID, an index, or meta information is used for identifying the AI or ML information.

In some implementations, the AI or ML information comprises one of: one or more AI or ML features, one or more AI or ML functionalities, or one or more AI or ML models.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network unit, comprising:
at least one memory; and
at least one processor coupled with the at least one memory and operable to cause the first network unit to:
transmit, to a second network unit, assistance information for a life cycle management (LCM) associated with an artificial intelligence (AI) or machine learning (ML) operation; and
receive, from the second network unit, a message being related to the assistance information.

2. The first network unit of claim 1, wherein the assistance information indicates at least one of:
an indication of whether to use the AI or ML operation to serve a user equipment (UE);
a suggested UE AI or ML operation to be activated or deactivated, or
a suggested network AI or ML operation to be activated or deactivated.

3. The first network unit of claim 1, wherein the assistance information indicates at least one of:
an expected arrival time of a user equipment (UE) from the second network unit to a third network unit,
an expected moving state of the UE, wherein the expected moving state is stationary or mobile,
an expected activity time of the UE in a radio resource control (RRC) connected state,
an expected idle time of the UE in an RRC inactive state or an RRC idle state;
whether the UE is a cell edge UE;
a moving velocity of the UE; or
a moving direction of the UE.

4. The first network unit of claim 1, wherein the message comprises an indication of AI or ML information in use at the second network unit or at a user equipment (UE), wherein the AI or ML information in use is determined based on the assistance information.

5. The first network unit of claim 1, wherein the at least one processor is further operable to cause the first network unit to receive, from the second network unit, a first indication of AI or ML information to be used at the second network unit.

6. The first network unit of claim 5, wherein the at least one processor is further operable to cause the first network unit to receive, from a user equipment (UE), a second indication of AI or ML information to be used at the UE.

7. The first network unit of claim 1, wherein the first network unit is a central unit (CU) and the second network unit is a distributed unit (DU).

8. The first network unit of claim 1, wherein the at least one processor is further operable to cause the first network unit to:
transmit, to a third network unit, a user equipment (UE) context setup request comprising the AI or ML operation in use at the second network unit or at a UE; and
receive, from the third network unit, a UE context setup response comprising an activated AI or ML operation.

9. The first network unit of claim 8, wherein the second network unit is a source distributed unit (DU), the third network unit is a target DU, and the first network unit is a central unit (CU).

10. The first network unit of claim 1, wherein the at least one processor is further operable to cause the first network unit to:
transmit, to a fourth network unit, a handover request comprising the AI or ML operation in use at the second network unit or at a user equipment (UE); and
receive, from the fourth network unit, a handover response comprising an indication of the AI or ML operation being activated by a third network unit.

11. The first network unit of claim 10, wherein the fourth network unit is a target central unit (CU) and the third network unit is a target distributed unit (DU).

12. The first network unit of claim 1, wherein an identifier (ID), an index, or meta information is used for identifying the AI or ML operation.

13. The first network unit of claim 1, wherein AI or ML information comprises one of:
one or more AI or ML features;
one or more AI or ML functionalities; or
one or more AI or ML models.

14. The first network unit of claim 1, wherein the AT or ML based operation comprises one of:
an AI or ML based channel state information (CSI) enhancement;
an AI or ML based beam management, or
an AI or ML based positioning accuracy enhancement.

15. A second network unit comprising:
at least one memory; and
at least one processor coupled with the at least one memory and operable to cause the second network unit to:
receive, from a first network unit, assistance information for a life cycle management (LCM) associated with an artificial intelligence (AI) or machine learning (ML) operation; and
transmit, to the first network unit, a message related to the assistance information.

16. The second network unit of claim 15, wherein the assistance information indicates at least one of:
an indication of whether to use the AI or ML operation to serve a user equipment (UE);
a suggested UE AI or ML operation to be activated or deactivated; or
a suggested network AI or ML operation to be activated or deactivated.

17. The second network unit of claim 15, wherein the assistance information indicates at least one of:
an expected arrival time of a user equipment (UE) from the second network unit to a third network unit;
an expected moving state of the UE, wherein the expected moving state is stationary or mobile;
an expected activity time of the UE in a radio resource control (RRC) connected state;
an expected idle time of the UE in an RRC inactive state or an RRC idle state,
whether the UE is a cell edge UE;
a moving velocity of the UE; or
a moving direction of the UE.

18. The second network unit of claim 15, wherein the at least one processor is further operable to cause the second network unit to:
perform the LCM based on the assistance information to determine AI or ML information in use at the second network unit or at a user equipment (UE); and
wherein the message comprises an indication of AI or ML information in use at the second network unit or at the UE.

19. A third network unit comprising:
at least one memory; and
at least one processor coupled with the at least one memory and operable to cause the third network unit to:
receive, from a first network unit or a fourth network unit, a user equipment (UE) context setup request comprising artificial intelligence (AI) or machine learning (ML) information in use at a second network unit or at a UE; and
transmit, to the first network unit or the fourth network unit, a UE context setup response comprising an activated AT or ML information.

20. A fourth network unit comprising:
at least one memory; and
at least one processor coupled with the at least one memory and operable to cause the fourth network unit to:
receive, from a first network unit, a handover request comprising artificial intelligence (AI) or machine learning (ML) information in use at a second network unit or at a user equipment (UE);
transmit, to a third network unit, a UE context setup request comprising the AI or ML information in use at the second network unit or at the UE;
receive, from the third network unit, a UE context setup response comprising an activated AI or ML information being activated by the third network unit; and
transmit, to the first network unit, a handover response comprising the activated AI or ML information.
